(19) United States
(12) Patent Application Publication
(10) Pub. No.: US 2005/0021521 A1
(43) Pub. Date: Jan. 27, 2005

(54) Embedding Internet message board display links

(76) Inventor: Robert E. Wycoff, Pasadena, CA (US)

Correspondence Address: KHORSANDI PATENT LAW GROUP, A.L.C.;Suite 312, 140 South Lake Ave., Pasadena, CA, 91101-4710, US

(21) Appl. No.: 10/611,476

(22) Filed: Jul. 1, 2003

Related U.S. Application Data
(60) Provisional application No. 60/394,058, filed on Jul. 3, 2002.

(51) Int. Cl. G06F 7/00

(52) U.S. Cl. 707/10

(57) ABSTRACT

The present invention will reserve lines of space within a message board display at predetermined positions for paid advertisement listings, such as hypertext links. The present invention will post purchased advertisement listing at the predetermined positions within the message board display in response to subscriber input. The present invention will post user messages to the message board display, adding new messages as they are input, while preserving the predetermined position of the advertising links.

### CROSS-REFERENCE TO RELATED APPLICATIONS

Priority is claimed to U.S. Provisional Patent Application entitled “Embedding Advertising Messages Within Internet Message Board Displays”, U.S. Provisional Patent Application Ser. No. 60/394,058, filed: Jul. 3, 2002, the disclosure of which is incorporated for all purposes herein in full by reference as if stated in full herein.

### FIELD OF THE INVENTION

The field of the present invention is computer systems, and specifically computer systems for internet-based message boards.

### BACKGROUND OF THE INVENTION

A message board system is a group of documents produced by users that are stored in a predetermined database on a server and then retrieved and displayed in a format consistent with the requirements of the Web site. They allow users to participate in on-going online discussions, to share thoughts, exchange opinions, and ask questions. Messages boards distinguish themselves from other Web site content because the information posted is largely user driven and allows others to access and read the material.

A message board system works by using one or more user interface applications that prompt users to input information into designated fields. Once completed, the input is submitted to a central server, recorded on one or more databases, and output to a web page that displays the information for others to read and reply to with their own message.

Message board displays are traditionally sorted by “date”, by “subject”, or “thread”. Messages displayed by “date” puts the most recent message at the top of the board, while messages displayed by “subject” show the title of the message and the numerical number of replies.

A message “thread” is a series of messages that are direct or indirect replies to each other and discuss a common subject. The message “thread” can be thought of as a family tree where a “parent” can have “children” or the replies to that message, if there is more than one reply to the message there can be multiple children and if there are replies to the replies a “generation” of parents, siblings, and children can occur all under the initial message.

FIG. 3a is a graphic representation depicting an exemplary thread-ordered display of an exemplary conventional message board system. FIG. 3b is a graphic representation depicting an exemplary subject-ordered display of an exemplary conventional message board system. FIG. 3c is a graphic representation depicting an exemplary date-ordered display of an exemplary conventional message board system.

The position of any particular message in a traditional message board display changes as users continue to input messages.

Although there are many ways to advertise on the Internet, advertisement on message boards has been very limited due to the nature of message board displays. One manner of Internet advertising is in the form of “banners”, which graphically display an advertiser's product and offer a link to a website or page that describes the particular product. Another advertising tool is in the form of “pop-ups”, where advertising screens randomly pop-up on a separate browser for users to view. Yet another popular advertising technique is web site listing positioning based on monetary value. Particularly, search engines selectively position subscriber web site listings based on a predetermined monetary value associated with each particular subscriber web site listing. During a search request, such search engines display these listings at predetermined positions, according to a ranking based on the predetermined monetary value associated with each listing. It is the object of the present invention to offer a unique technique in which to advertise within a message board system.

In a traditional message board system, revenue-generating banner advertisements can be displayed around the perimeter of the message board display. Traditional message board web sites may also display pop-up ads superimposed over, and hiding, the message board display; the entire message board display cannot be viewed until the pop-up ad window is closed. A better way of advertising on message boards is needed.

### SUMMARY OF THE INVENTION

In contrast to traditional message board system advertising, an exemplary embodiment of the present invention would provide tools and output displays to embed advertisements as Internet site listings within a message board display. The exemplary embodiment of the present invention would designate specific permanent lines embedded within the list of messages that are used to display these listings. The exemplary embodiment of the present invention would provide a method for inputting Internet site listings to be displayed within a message board system. The exemplary embodiment of the present invention will reserve lines of space within a message board display at predetermined positions for paid advertisement listings, such as hypertext links. The exemplary embodiment of the present invention will post purchased advertisement listings at predetermined positions within the message board display in response to subscriber input. The exemplary embodiment of the present invention will post user messages to the message board display, adding new messages as they are input, while preserving the predetermined position of the advertising links.

Further, the exemplary embodiment of the present invention would, using a server computer, provide a network of message board systems that would maintain a listings database containing site listings, provided by subscribers. Each site listing would include a title and/or description of the content of the respective site, a network address at which the site can be accessed, and a predetermined value to be paid by the subscriber as a subscription fee for the site listing. In response to an accessed message board, the server would provide a message-board-embedded listing based on the subscription fees to be paid by the subscriber. Through an account monitoring interface, subscribers would monitor their listings and modify their account information and subscription fees automatically at any time.

Still further, the exemplary embodiment of the present invention would provide a system of purchasing and placing paid Internet site listings on specific reserved lines embedded within a message board system display—that is, the Internet site listing advertisement would be positionally displayed; the position would be pre-determinable.

In the exemplary embodiment, the present invention would provide methods and systems for advertisers and Web site owners, collectively referred to herein as “subscribers”, to purchase and display Internet site listings embedded in the display of a message board system and/or in a display, or the displays, of a network of message board systems. The exemplary embodiment of the present invention would provide subscribers methods and systems for purchasing positionally consistent placement of their embedded message board display advertisement. The exemplary embodiment of the present invention would further provide subscribers methods and systems for editing their message board display advertisement information. A feature of the exemplary embodiment of the present invention is that a subscriber would purchase a positionally constant advertisement in a message board system at a predetermined cost to the subscriber. The exemplary embodiment of the present invention would provide methods and systems for posting a paid internet site listing embedded within the content of the message board. The exemplary embodiment of the present invention would provide a method for embedding a hypertext link in an Internet message board display, the method compromising displaying on a predetermined set of particular display line positions within a fixed number of display line positions on a particular Internet message board a plurality of offer displays.

In the exemplary embodiment of the present invention, communications between subscribers and a particular message board site would be conducted using the Internet, electronic interfaces, and a central controller. A subscriber who wishes to purchase an internet site listing position on the particular message board, would access a central controller from a remote computer. The subscriber will then be able to buy an embedded advertising link offer (“EALO”) by choosing an available predetermined space within the particular message board system display. Then by specifying an Internet site listing, a title, description and other conditions required, a subscriber will be able to post an EALO link (such as a hypertext link) to the requested position within the particular message board.

It will be understood by someone with ordinary skill in the art that the present invention can also be implemented in a central message board network that would provide subscribers with the opportunity to post an EALO link (such as a hypertext link) to a specific message board within a network of message board systems.

In the exemplary embodiment implemented for a single message board site, an exemplary available advertising space is available on, for example, line 25 of a 100 line message board page. An exemplary EALO would, for example, specify an internet site listing www.example.com, with a subject of “I Sell Examples”, and a description of “Lowest examples on the internet”.

Once the subscriber has clicked on an EALO, the subscriber would input subscriber information, a site listing identification for a site listing ad, subject and description information. Once the subscriber has input the information, the central controller of the present invention would store the information in one or more databases. The ad information would be stored so that the EALO and the subscriber information is related to the subject and description information. In a network embodiment, the particular EALO would also be related to an identification of a particular message board, such as a particular message board site. Returning to the exemplary embodiment of the present invention, the subscriber will be prompted, as further described below, to provide payment for the posting of the EALO. The exemplary embodiment of the present invention would then post the EALO via one of numerous posting means, including a world-wide-web interface, electronic email, facsimile, or postal mail, to the selected EALO position in the particular message board display.

In the exemplary embodiment of the present invention, before posting the subscriber's EALO, the submitted information would be edited for authenticity and accuracy. The central controller would require that the subscriber input a credit card number. The central controller would verify the credit card information and would verify that sufficient credit is available to complete the transaction. The central controller would then post the EALO to the particular message board system. In order to post the EALO, the present invention would retrieve the stored data for the particular EALO from the database(s), would provide the central controller with the location, such as, e.g., the internet address, to the specific message board and line space within the message board network. In the exemplary embodiment, EALOs would be displayed with distinguishing color or display themes to visually distinguish the EALOs from other message board display content.

In an alternative exemplary embodiment of the present invention, the central controller would provide three separate interfaces: 1.) user interface; 2.) site-listing interface; and 3.) message board interface.

In the alternative exemplary embodiment, the user interface would provide non-subscriber users with an input interface with which to create the message board content. The user interface would prompt users to input requested information or would otherwise obtain user information, including user profile information, user account information, and user content. The user interface would store the user profile information, user account, and user content in one or more databases.

In the alternative exemplary embodiment, the site-listing interface would prompt subscribers to input EALO-specific listing and purchase information, such as Web site listing, brief description of the listing, title of listing, company information, contact information and payment preferences. The site-listing interface would provide subscribers with updatable views of each EALO belonging to the subscriber for EALO maintenance.

In the alternative exemplary embodiment, the message board interface would create message board displays for each message board page of a particular message board by retrieving EALO-specific data from the appropriate databases, and user-content information from the appropriate databases. The message board interface would format the display and would output the data to the particular message board display. Depending on the embodiment, the message board interface would post user messages and subscriber EALOs to a single message board or to a network of messages boards.

The exemplary embodiment of the present invention would provide a listing of Internet sites advertised within a message board system. A listing server would be connected to a network accessible by a plurality of users. The listing server would access an EALO listing database containing a plurality of paid site listings. Each paid site listing would include subscriber identification information, title information, description information, network address information, subscriber fee information, message board display information including, for example, a predetermined position field within the message board display, such as would be determined by the subscriber's desired position within the message board system, and an expiration date.

In the exemplary embodiment subscribers would pay a monetary amount for a defined subscription period for a particular message board display position. The monetary amount may be determined by a ranking of the particular message board display system within the entire message board display. Alternatively, the monetary amount may be a set amount that would apply to all of the possible listings in the message board system.

In the exemplary embodiment, the present invention would embed in a fixed position within a message board system display a text-based internet site listing “advertisement”, or simply “ad”. The present invention would maintain the position of the ad at a permanent and predetermined line space—the line position of the ad would be maintained even though user information is continuously updated, changing the display positioning of the remainder of the content of the message board. Thus, the present invention would provide database-driven text advertising that combines a user-driven message board database and an internet site listing database which both output by the exemplary embodiment of the present invention into a single message board display. Using the exemplary embodiment of the present invention, subscribers would place their respective Internet listing advertisement in a specified display location within a message board display such that the advertisement will, until the listing expires, always be displayed in the specified display location within the message board display.

In a further alternative exemplary embodiment of the present invention (sometimes referred to herein as the “exemplary bid embodiment”), a particular advertisement will not be displayed in a permanent, predetermined display location. Instead, in the further alternative exemplary embodiment, a listing server would provide advertisement position ranking according to a denominated value associated with the listing. Subscribers would pay a monetary value of their own choosing (a bid) as a subscription fee to list an advertisement with the listing service for a defined subscription period. The higher the bid amount paid for a given subscription period in relation to other advertisers, the higher the particular advertisement's ranking on the services EALO system.

In the exemplary bid embodiment, subscribers would be able to monitor their advertisement's ranking and would be allowed to modify their advertisement's ranking by lowering or raising their subscription fees. Changes to subscription fees, and consequently ranking position, would be handled by the listing server, such as at regular intervals.

### BRIEF DESCRIPTION OF THE DRAWINGS

These and other features of the present invention are more fully set forth in the following description of exemplary embodiments of the invention. The description is presented with reference to the accompanying drawings in which:

FIG. 1 is a high-level block diagram depicting an exemplary system architecture of an exemplary embodiment of the present invention;

FIG. 2 is a block diagram depicting an exemplary architecture of the central controller in an exemplary embodiment of the present invention;

FIG. 3a is a graphic representation depicting an exemplary thread-ordered display of an exemplary conventional message board system;

FIG. 3b is a graphic representation depicting an exemplary subject-ordered display of an exemplary conventional message board system;

FIG. 3c is a graphic representation depicting an exemplary date-ordered display of an exemplary conventional message board system;

FIG. 4a is a graphic representation depicting posting an exemplary EALO and exemplary new message in an exemplary thread-ordered display of an exemplary message board system;

FIG. 4b is a graphic representation depicting posting an exemplary EALO and exemplary new message in an exemplary subject-ordered display of an exemplary message board system;

FIG. 4c is a graphic representation depicting posting an exemplary EALO and exemplary new message in an exemplary date-ordered display of an exemplary message board system;

FIG. 5 is a block diagram depicting high-level functions of an exemplary site listing interface in an exemplary embodiment of the present invention;

FIG. 6 is a block diagram depicting high-level functions of an exemplary user interface in an exemplary embodiment of the present invention;

FIG. 7 is a block diagram depicting high-level functions of an exemplary EALO interface in an exemplary embodiment of the present invention;

FIG. 8 is a high level flow diagram depicting high-level logic functions of an exemplary EALO purchase interface in an exemplary embodiment of the present invention;

FIG. 9 is a block diagram depicting high-level functions of an exemplary message board interface for posting user messages to an exemplary message board system in an exemplary embodiment of the present invention;

FIG. 10 is a block diagram depicting high-level functions of an exemplary message board interface for posting both user messages and subscriber advertisements to an exemplary message board system in an exemplary embodiment of the present invention;

FIG. 11 is a graphic illustration depicting illustrative user and subscriber interactions with an exemplary embodiment of the invention;

FIGS. 12a through 12c are graphic representations of an exemplary message board administration interface in an exemplary embodiment of the present invention;

FIG. 13 is a block diagram depicting high level message board administration interface functional components in an exemplary embodiment of the invention;

FIG. 14a is a block diagram depicting high level EALO denominated value listing account management functions performed by an exemplary denominated-value listing service of an exemplary bid embodiment of the present invention;

FIG. 14b is a graphic representation depicting an exemplary listing update interface of the exemplary bid embodiment of the present invention;

FIG. 15 is a graphic representation depicting an exemplary message board updated with results of a denominated-value EALO service in the exemplary bid embodiment of the present invention;

FIG. 16 is a graphic representation depicting an exemplary message board updated with results of a first bid in the exemplary bid embodiment of the present invention;

FIG. 17 is a graphic representation depicting an exemplary message board updated with results of a second bid in the exemplary bid embodiment of the present invention;

FIG. 18 is a graphic representation depicting an exemplary message board updated with results of a third bid in the exemplary bid embodiment of the present invention;

FIG. 19 is a logic flow diagram depicting high level logic flow of the denominated-value EALO service in the exemplary bid embodiment of the present invention;

FIG. 20 is a graphic representation of an exemplary Add New EALO interactive user interface screen in the exemplary bid embodiment of the present invention; and

FIG. 21 is a graphic representation of an exemplary Update EALO interactive user interface screen in the exemplary bid embodiment of the present invention.

### DETAILED DESCRIPTION OF THE INVENTION

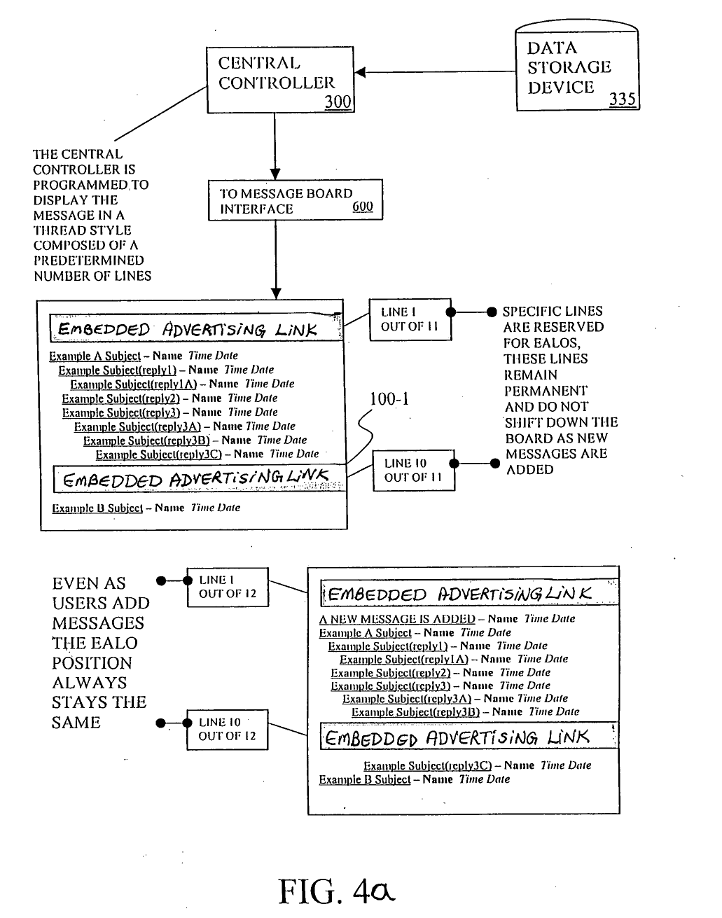

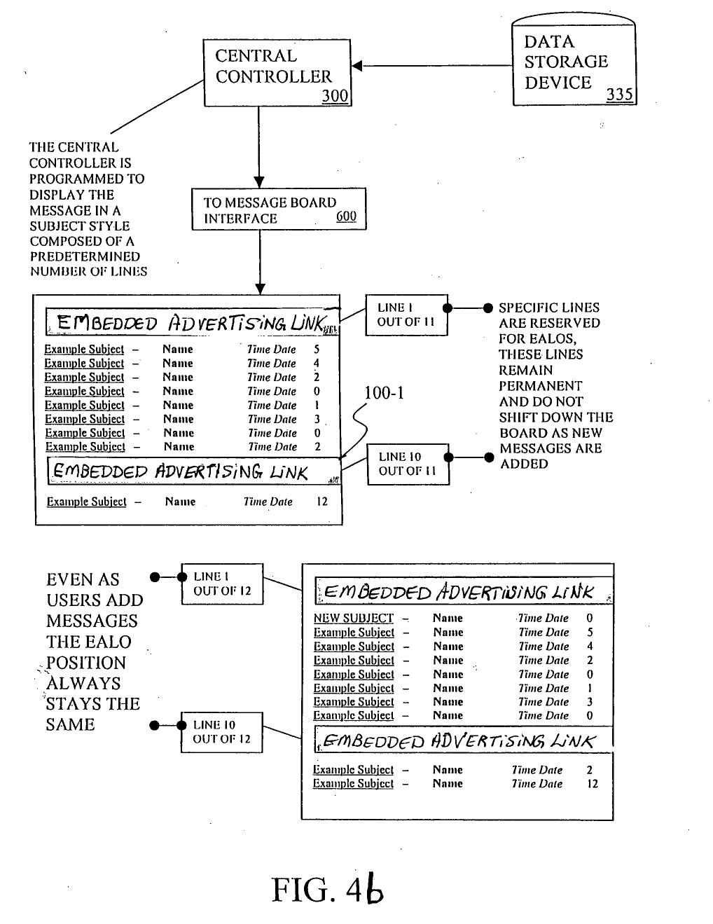

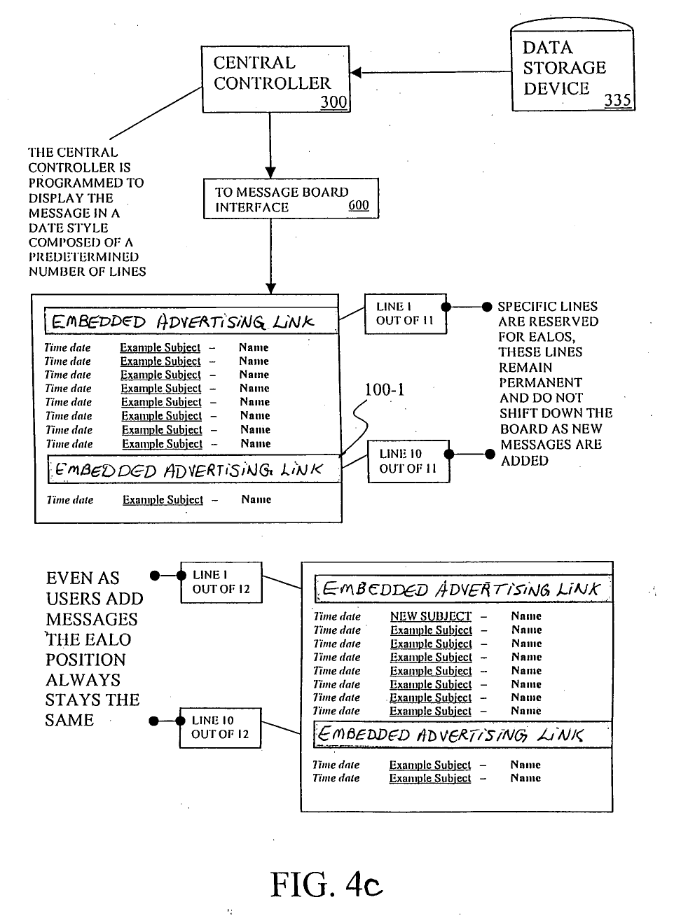

Conventional message board systems store input and output documents, created by a user, in a central server. The stored user documents (user messages) sometimes take the form of title, name of user, date, time, and message. The present invention will embed subscriber advertisements in message board message output so that each subscriber ad will be displayed at predetermined lines within the message board display. As depicted in FIGS. 4a, 4b and 4c, the present invention will reserve lines of space within a message board display at predetermined positions for paid advertisement listings, such as hypertext links. Paid advertisement listings would be available for purchase by a subscriber using an EALO purchase system that would be provided by the present invention. Using the EALO purchase system, a subscriber could purchase an embedded advertising link offer by electronic or non-electronic means.

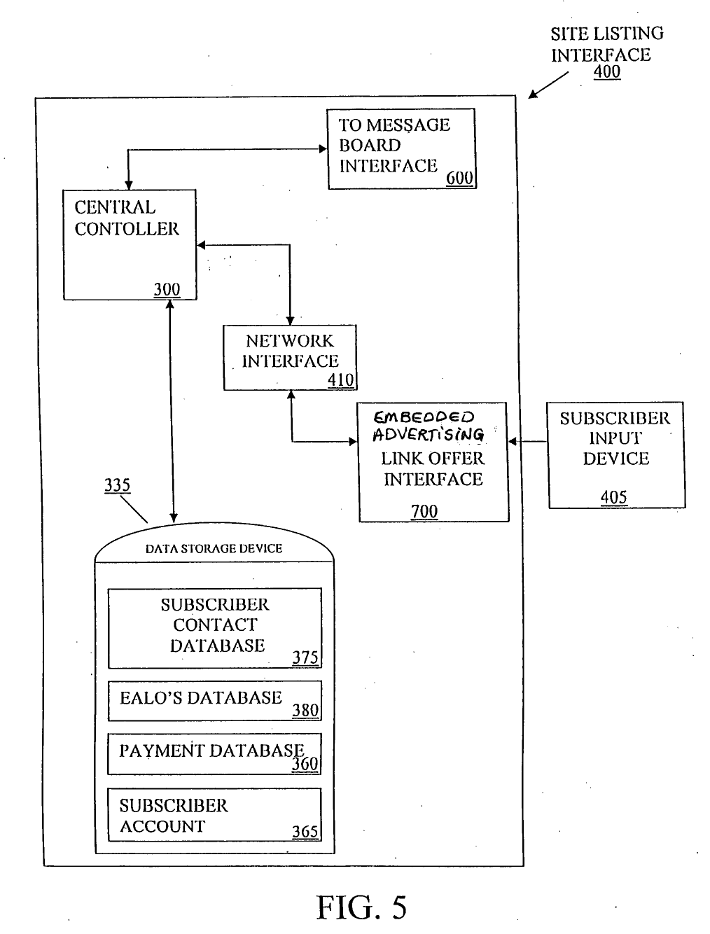

FIG. 4a is a graphic representation depicting posting an exemplary EALO and exemplary new message in an exemplary thread-ordered display of an exemplary message board system. As depicted in FIG. 4a, a central controller 300 would retrieve data input by users and subscribers from a data storage device 335. The data storage device 335 would contain one or more databases which are described below with respect to FIGS. 5 through 10. Among other things, the data storage device 335 would contain databases containing message board documents and EALO information for display on the message board.

In the exemplary embodiment depicted in FIG. 4a, the message board interface 600 would display the messages in “thread” style; a predetermined number of lines would be available per page for display of these messages. The message board interface 600 would reserve predetermined lines within the entire message board display for embedded advertising links for purchase by a subscriber for a monetary value. The position of the reserved EALO lines would not shift up or down within the message board display as users input messages. The present invention would provide a system through which users can input and read messages while at the same time subscribers may select and purchase an EALO display position, and input EALO information for display.

The process described herein with respect to the thread-ordered style display depicted in FIG. 4a is similar for date-ordered and subject-ordered message board displays. As depicted in FIGS. 4b and 4c respectively, the message board interface 600 would display the information by date-order (FIG. 4b) or by subject (FIG. 4c) according to a user request to view the messages of the particular message board in the specified style. In the exemplary embodiment of the invention, the exemplary message board system would display messages in response and according to a user request; subscriber-purchased EALOs would be displayed on predetermined lines within the message board display; the location of subscriber-purchased EALOs would reflect a specification by the relevant subscriber as to selection of and payment for a particular EALO space.

System Architecture

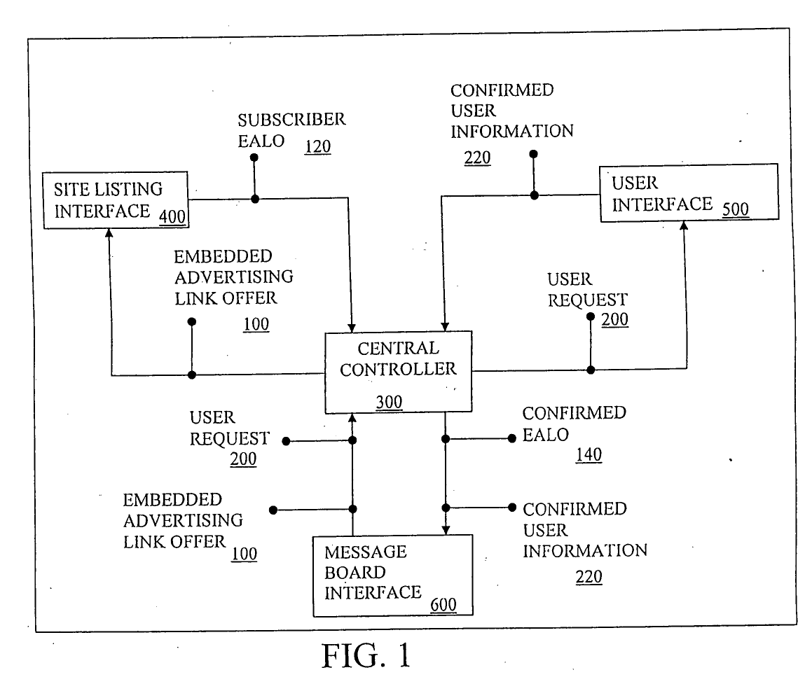

FIG. 1 is a high-level block diagram depicting an exemplary system architecture of an exemplary embodiment of the present invention. As depicted in FIG. 1, the exemplary system of the present invention compromises a central controller 300, a site listing interface 400, a user interface 500, and a message board interface 600 each of which are the input and output gateways for communications with the central controller 300. Each one of these interface nodes is connected to the Internet using a plurality of public networks.

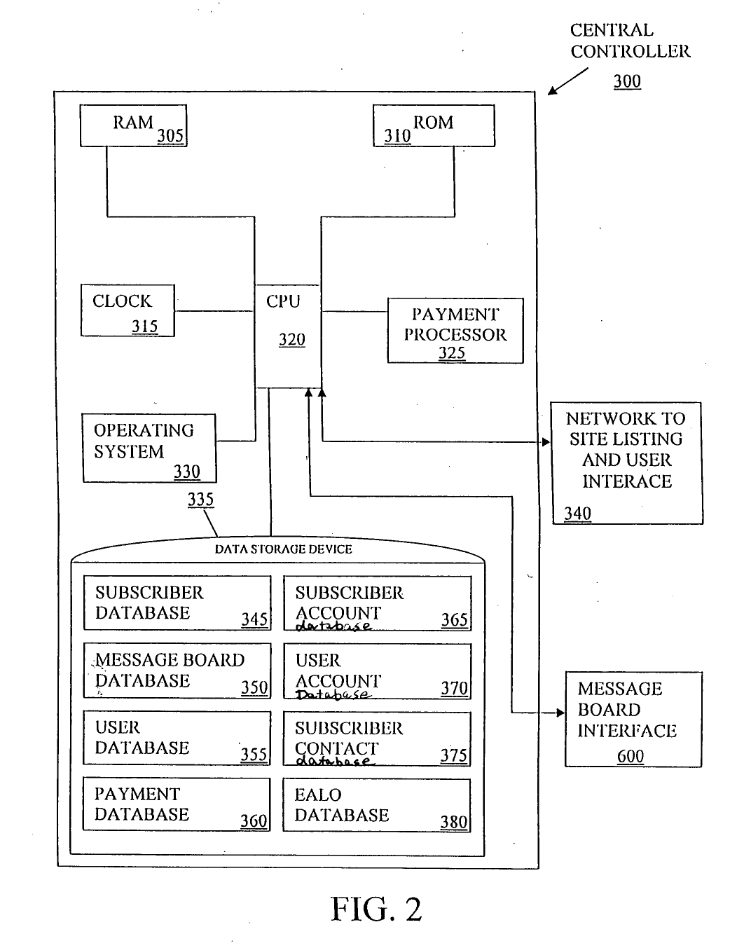

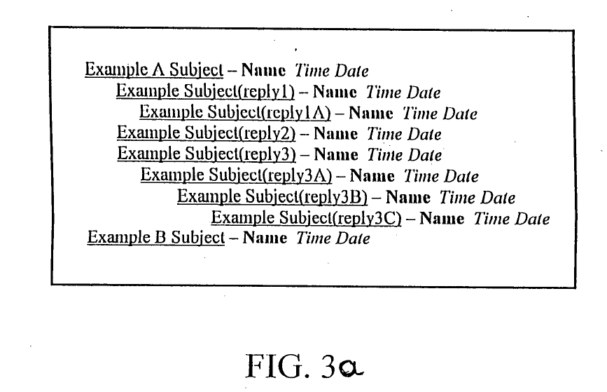

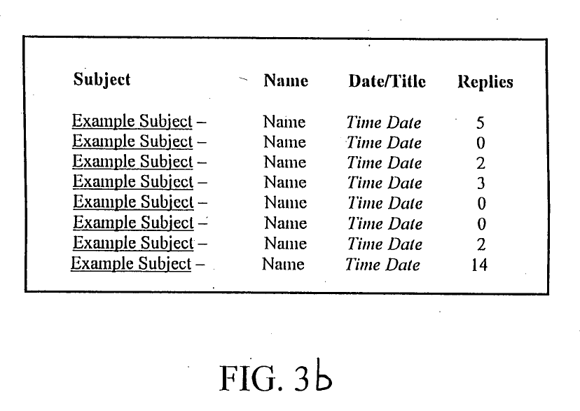

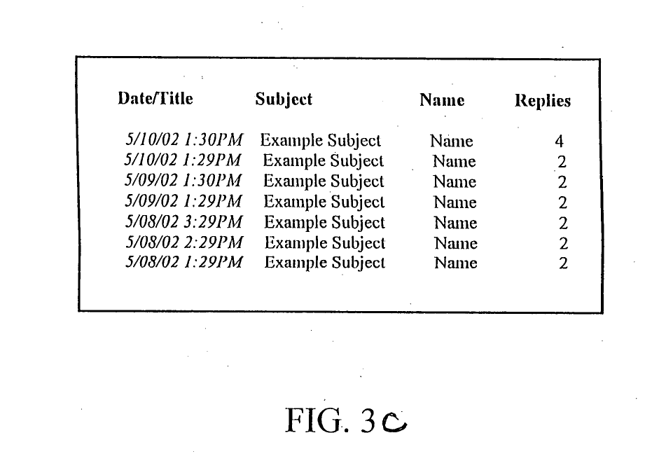

FIG. 2 is a block diagram depicting an exemplary architecture of the central controller in an exemplary embodiment of the present invention. As depicted in FIG. 2, central controller 300 would include central processor (“CPU”) 320, RAM 305, ROM 310, payment processor 325, operating system 330, network interface 340, a data storage device 335, and message board interface 600.

A conventional web server or network of web servers may be used as a central controller 300. In the exemplary embodiment, the central controller 300 operates as a web server, both receiving and transmitting EALOs generated by subscribers and submitted messages from users. Simultaneously, the central controller 300 receives and transmits these EALOs and messages that make up the message board system display. Through network interfaces, the central controller 300 would transmit the combined data into one single message board system or to a network of message boards.

Continuing with FIG. 2, the payment processor 325 comprises a system that would support the exchange of payments and charges with respect to a particular EALO. In an alternative embodiment, Payment processor 325 may also be configured as part of CPU 320. In the exemplary embodiment, processing of credit card transactions by payment processor 325 would be supported with commercially available software.

In the exemplary embodiment of the invention, data storage device 335 would be a conventional magnetic-based hard disk storage unit containing databases used in processing in the present invention, including subscriber database 345, message board database 350, user database 355, payment database 360, subscriber account database 365, user account database 370, subscriber contact database 375, and embedded advertising link offer (EALO) database 380. The description of data storage device 335 of the exemplary embodiment as a conventional magnetic-based hard disk storage device is illustrative and is not a limitation of the invention.

In the exemplary embodiment, the exemplary system would maintain on the subscriber database 345 information about subscriber/advertisers. Subscriber/advertiser information maintained on the subscriber database 345 would include, for example: subscriber ID, password, name, company, payment preferences, type of business, and Web site listing information for posting to the message board, e.g., through the message board interface 600, according to a corresponding embedded advertising link offer 100 (depicted in, e.g., FIG. 1).

Message board database 350 would contain message documents input by users. In response to receipt of message document input, the system would activate the message board interface 600. Message document data may include, for example, user name, user email address, title of user message, and message content.

User database 355 would contain information about users, including, e.g., user name, user password, IP (Internet Protocol) address, and user email address.

Payment database 360 would contain information about all payments made by subscribers. Payment database 360 information would include, e.g., advertiser name, advertiser ID number, EALO identification for EALO purchased, amount of payment, termination date of EALO, and message board identification. Payment information would be recorded on the database after the subscriber has input all the requested information in input fields provided by the system and the information has been edited. As will be described further below, credit card payment information would be authenticated, such as by electronically submitting a request to the respective credit card company to confirm that the subscriber of the credit card number provided has sufficient credit to complete the particular transaction. If there is sufficient credit, the credit card company will transmit a confirmation number; the system will store the confirmation number in the payment database and will designate in a data field for the particular transaction that the transaction is complete; the central controller 300 will then post the EALO content provided by the subscriber to the appropriate message board display.

Subscriber account database 365 would contain information pertaining to subscriber/advertiser accounts including statistical subscriber information. Subscriber account database 365 information would include, e.g., subscriber name, subscriber company name, a number representing a frequency of EALO purchases by the subscriber company, and a number representing a number of times users click on each particular EALO to which the subscriber subscribes. Subscriber account database 365 statistical information would be collected by the system and/or pulled from other system databases.

User account database 370 would contain information pertaining to user accounts including statistical user information. User account database 370 information would include, e.g., user identification, identification of message boards on which the relevant user has posted messages, total number of message postings, total number of replies, and contact information. The system would compile user account data information from user usage of the system and from other system databases.

Subscriber contact database 375 would contain, e.g., subscriber identification, subscriber comments, questions, subscriber company information, and subscriber contact information. The system would record on the Subscriber contact database 375 contact and interaction between subscribers and the message board web site.

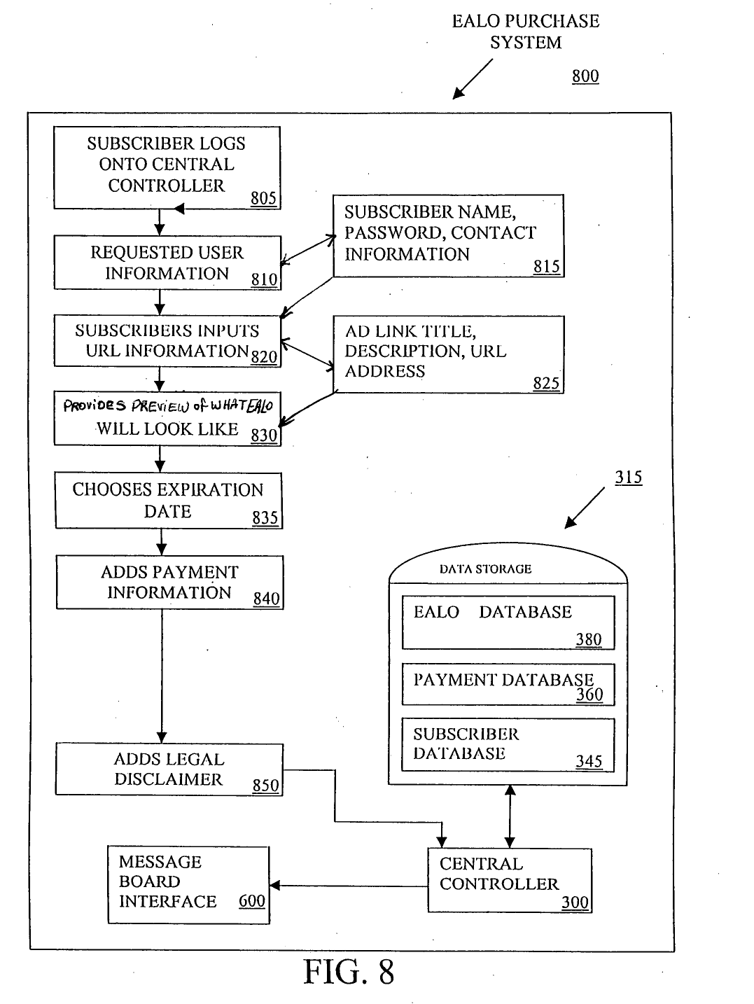

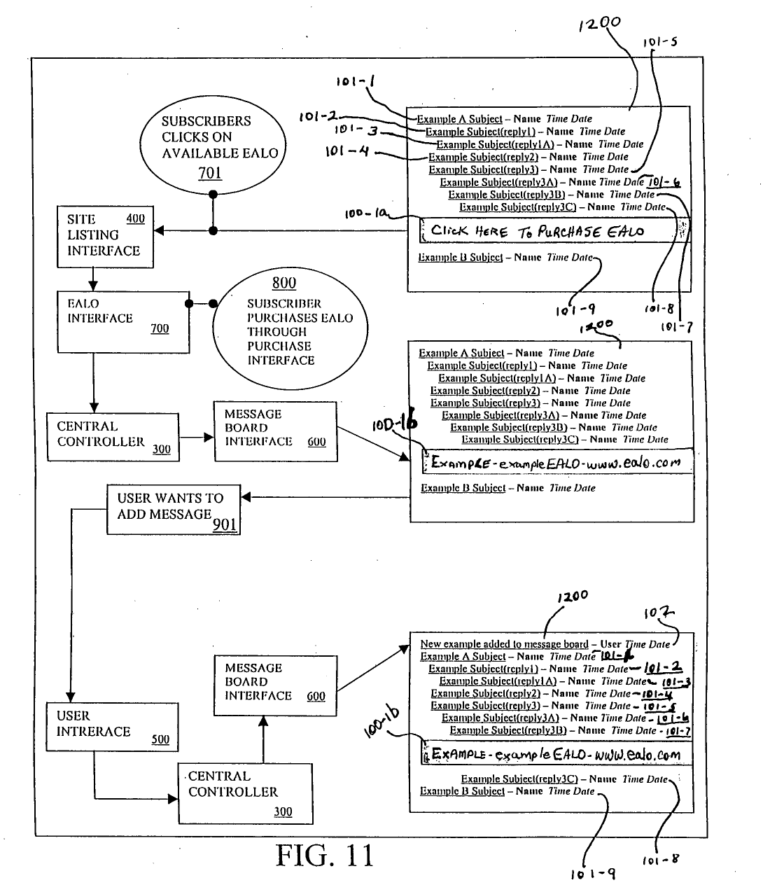

In the exemplary embodiment, embedded advertising link offer (EALO database 380 would contain for each subscriber EALO, subscriber identification, message board identification, designated line number, and expiration date. FIG. 8 is a high level flow diagram depicting high-level logic functions of an exemplary EALO purchase interface in an exemplary embodiment of the present invention. As depicted in FIG. 8, the system would collect information from each subscriber and would record the information collected on the EALO database 380, the payment database 360, and/or the subscriber database 345. After the information is stored on the EALO database 380, as depicted in FIG. 11, the message board interface 600 of the system would use information from the EALO database 380 for display on the particular predetermined line associated with the purchased EALO in the message board display associated with the purchased EALO.

It will be understood by someone with ordinary skill in the art that the data architecture described herein is illustrative and non-limiting. Other data relationships could be provided without departing from the spirit of the present invention. For example, in one embodiment, a message board site listings database is accessible by the listing server; the site listings database comprises a plurality of site listings; each site listing would, for example, comprise, possibly among other things, an embedded advertising link offer identifier, and a Web site address. An embedded advertising link offer database would be provided that would be accessible by the listing server. The embedded advertising link offer database would comprise a plurality of embedded advertising link offers. Each embedded advertising link offer would, for example, comprise, possibly among other things, an embedded advertising link offer identifier, a corresponding message board identifier, and an identifier of a particular display position within a fixed number of displayable positions on a message board that corresponds to the message board identifier.

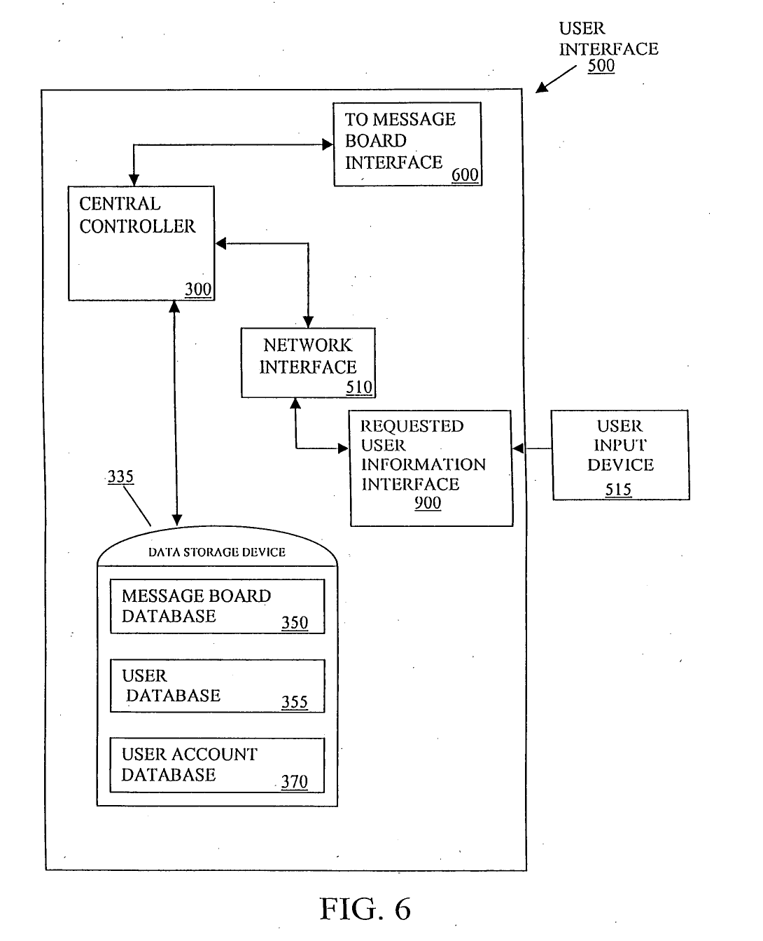

As depicted in FIG. 2, the system would provide a Network to site listing and user interface 340. The Network to site listing and user interface 340 would be a gateway through which the central controller can communicate with users and subscribers through respective user interface 500 (shown in FIG. 6) and site listing interface 400 (shown in FIG. 5). In one exemplary embodiment, Network to site listing and user interface 340 would be connected with the Internet or other commercial on-line service.

While the above embodiment describes a single computer acting as central controller 300, it will be understood by someone with ordinary skill in the art that this configuration is illustrative; the functionality of the central controller 300 can alternatively be distributed over a plurality of computers without departing from the spirit of the invention.

FIGS. 5 and 6 depict high-level functions of an exemplary site listing interface 400 and user interface 500 respectively. In the exemplary embodiment, the exemplary site listing interface 400 and user interface 500 communicate with the central controller 300. In the exemplary embodiment, both the exemplary site listing interface 400 and user interface 500 would be performed by conventional server computers that are connected to the central controller 300 through a network system. In an alternative embodiment, these interfaces 400 and 500, would be performed by the central controller 300.

Referring now to FIG. 5, the site listing interface 400 would provide an embedded advertising link offer interface 700 that would prompt subscribers to select one or more available EALOs. Subscribers would input EALO selections using a subscriber input device 405. The embedded advertising link offer interface 700 would communicate with the central controller 300 through a Network interface 410. In the exemplary embodiment of the present invention, the Network interface 410 would connect the site listing interface 400 to the central controller 300 through a WAN hub. The WAN hub would serve as a primary communication link between the central controller 300 and the various interface computer devices.

A subscriber would input information into the site listing interface 400 using a subscriber input device 405. The exemplary subscriber input device 405 would have an on-line enabled connection, and a keyboard, or other means capable of inputting information.

Message board interface 600 would generate a display (post) of the information collected through the site listing interface 400, and would transmit the display to the appropriate message board display.

Embedded advertising link offer interface 700 would provide an input/output interface enabling the purchase of an EALO, change or update of an account, and update of a current EALO advertisement displayed on a message board.

Data storage device 335 would be accessibly connected to the central controller 300. In the exemplary embodiment of the present invention, data storage device 335 would be housed in the central controller 300. In an alternative exemplary embodiment, the data storage device 335 would be maintained on a separate server system. Subscriber contact database 375, EALO database 380, payment database 360, and subscriber account database 365, are the main storage devices utilized during subscriber interaction with the site listing interface 400; the system uses these databases to generate and process a subscriber account and complete the purchase and display of an embedded adverting link offer (EALO). The site listing interface 400 would prompt the system to store information, receive payment validate an EALO purchase, and release an EALO ad to the relevant message board to display. The site listing interface 400 would control the placement and purchase of an EALO and if any errors occur during the process of storing this information, would notify the subscriber with an error message.

Referring now to FIG. 6, a user interface 500 would prompt users to input information and messages. Users would input information and messages using a user input device 515. A requested user information interface 900 would receive input from user input device 515. The requested user information interface 900 would communicate with the central controller 300 through a Network interface 510. User input information would be stored on, e.g., message board database 350, user database 355 and user account database 370, all of which would be contained on data storage device 335.

In one embodiment of the present invention, network interface 510 would connect the requested user information interface 900 and other elements of the user interface 500 to the central controller 300 through a WAN hub; the WAN hub would serve as a primary communication link with the central controller 300 or controllers and interface devices. In an alternative embodiment, the user interface 500 and requested user information interface 900 are housed in, or are otherwise performed by, the central controller 300.

User input device 515 is a means by which a user inputs the information into the user interface. Exemplary user input device 515 would have an on-line enabled connection and keyboard input, or other electronic means capable of transmitting the appropriate information.

Message board interface 600 would generate a display of the information collected from a user through the user interface. The generated display would report, e.g., the title of a message, the message itself, or email address; the system would determine whether to display the messages in a date, subject, or thread style.

Requested user information interface 900 would be an input/output interface that would prompt and direct the user to input information that would be used to generate the documents that make up the message board system.

User interface 500 would access data storage device 335. User interface 500 would specifically access the message board database 350, user database 355, and user account database 370. Through the user interface 500, the system would generate and process user accounts and user requests to complete the posting of a message within a message board system.

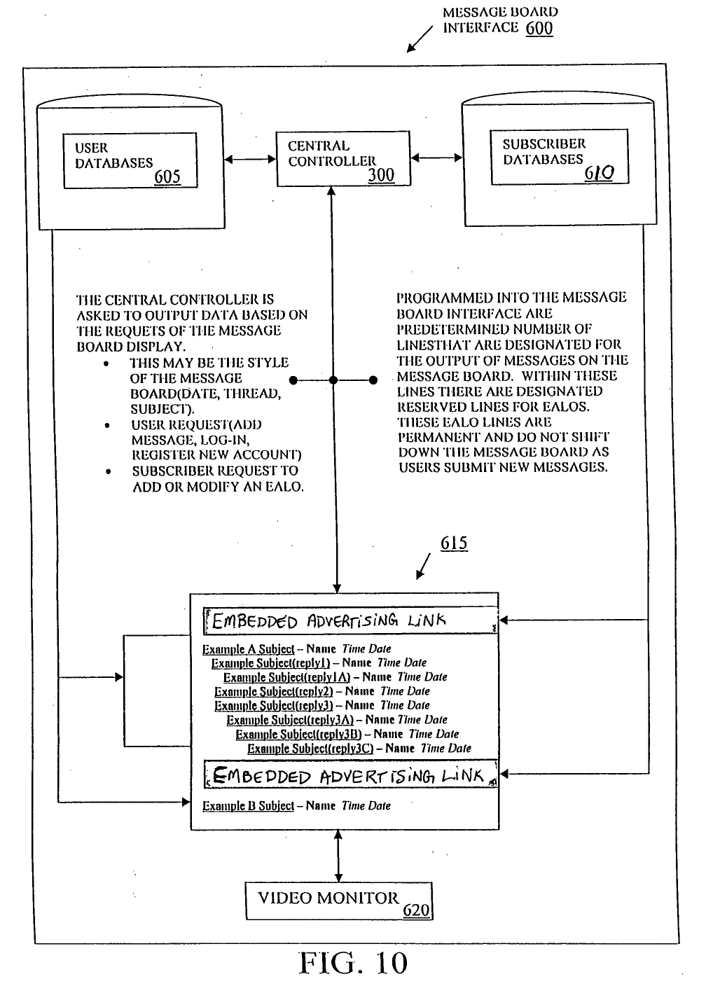

Referring to FIG. 10, the message board interface 600 would provide a communications interface for inputting and outputting data from the central controller 300 to users and subscribers. The message board interface 600 would determine a first specific number of lines per page of a message board committed to user messages. The message board interface 600 would determine a second specific number of lines per page of a message board committed committed to EALOs.

Appendix A hereto, a part hereof for all purposes, and incorporated herein by reference, contains exemplary message board interface program code to create a display of message board user messages and subscriber embedded advertising link displays.

The message board interface would be composed of Web site applications that perform functions which enable the process by which users and subscribers input and output information. These applications will be programmed to determine the maximum number of lines per message board page and to determine at which lines to insert EALOs. The message board interface 600 will be the portal by which users and subscribers view the information requested. The message board interface 600 will also provide a navigation hub to the central control 300 and the interfaces to submit messages and EALOs. The message board interface 600 will communicate with the central controller 300 to access user databases 605 and subscriber databases 610 to generate and output data to the message board display 615. The message board interface 600 will generate the message board display 615 to a display or video monitor 620. As will be understood by someone with ordinary skill in the art, a plurality of users and/or subscribers can be in communication with the central controller through, e.g., the message board interface 600, over the Internet. The message board display 615 will be generated through the message board interface 600 according to each particular user or subscriber request.

When central controller 300, site listing interface 400, user interface 500 and message board interface 600 are configured as web servers, conventional communications software may be used.

In an alternative exemplary embodiment of the present invention, although each EALO (Embedded Advertising Link Offer) will be at a fixed, predetermined display location, a particular advertisement will not be displayed in a permanent, predetermined display location for a specified amount. Instead, in the alternative exemplary embodiment, each EALO within a message board will be ranked; further, a listing server would provide advertisement position ranking according to a denominated value associated with the EALO listing. Subscribers would pay a monetary value of their own choosing (a bid) as a subscription fee to list an advertisement with the listing service for a defined subscription period. The higher the bid amount paid for a given subscription period in relation to other advertisers, the higher the particular advertisement's ranking on the services EALO system.

Various alternative ranking schemes may be used to rank a particular EALO within a particular message board. For example, in one ranking scheme, the EALO at the top of the first message board page will have the highest position ranking; each subsequent EALO below the top first page EALO will have a subsequently lower ranking.

As will be understood by someone with ordinary skill in the art, in message board systems, the first viewable page of a message board typically presents the most current messages. Message board users often check the first page of a message board and do not continue to any subsequent pages. One ranking scheme would be to post the same EALOs that are on the first page in the same order at the same position on each subsequent message board page. Another ranking scheme would be to post distinct second-page, and subsequent-page EALOs on the second and subsequent pages of the message board; the distinct second-page, and subsequent-page, EALOs would have lower ratings than the lowest-ranked first page EALO.

As is described in more detail below, in an exemplary bid embodiment, when an advertiser wants to place an advertisement on a particular message board, the advertiser will bid on the highest ranked EALO. If the advertiser's bid for that EALO is the highest bid, then the advertiser will be awarded that EALO, for the duration of a subscription period, unless and until another advertiser places a higher bid.

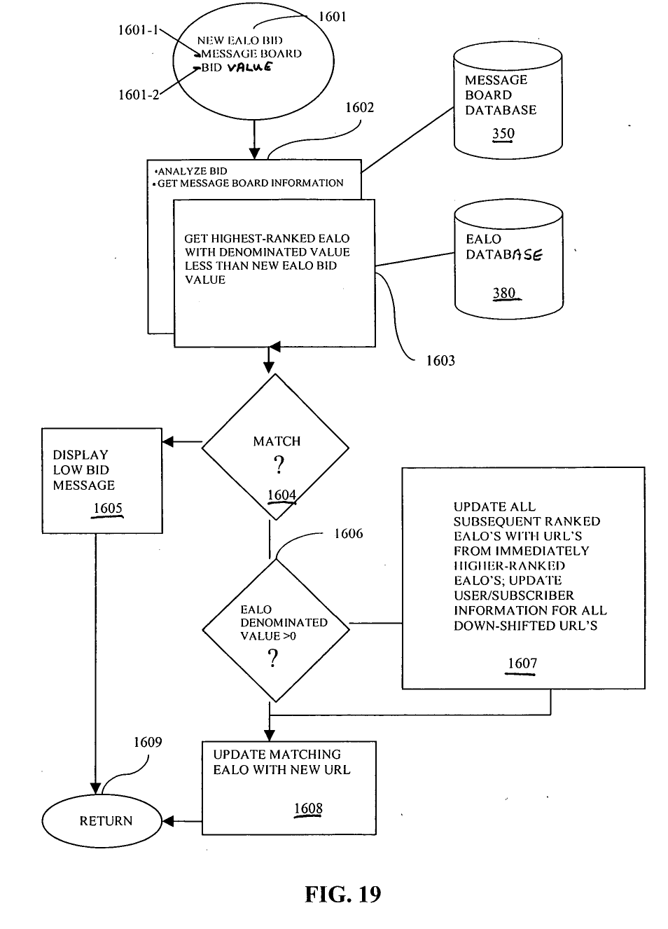

FIG. 19 is a logic flow diagram depicting high level logic flow of the denominated-value EALO service in the exemplary bid embodiment of the present invention. As depicted in FIG. 19, a user/subscriber would input a new EALO bid 1601 comprising, among other things, a Message Board identifier 1601-1 and a bid 1601-2. In function 1602, the exemplary bid system embodiment would analyze the New EALO Bid 1601 and get message board information from the Message Board Database 350 for the message board corresponding to the Message Board 1601-1 identified in the New EALO Bid 1601. From the EALO database 380, the exemplary bid system embodiment would get the highest-ranked EALO with a denominated value less than the New EALO Bid Value 1601-2 (sometimes referred to herein as the “matching” EALO). In the test function 1604, the exemplary bid embodiment system would test to determine if such a matching EALO exists. If there is no matching EALO with a denominated value less than the New EALO Bid Value 1601-2, then the exemplary bid embodiment system would display 1605 a message for the user/subscriber (such as to a display monitor connected to the user/subscriber's computer) to report that the bid is lower than all previous currently active bids, and that there are no open EALOs, before returning 1609 to the main logic function of the exemplary bid embodiment system. If, on the other hand, there does exist an EALO with a denominated value less than the new EALO bid value 1601-2, then the exemplary bid embodiment system would test 1606 the denominated EALO value to determine whether it is greater than zero. A zero denominated EALO value means that the EALO is open and that no currently active bid applies to that EALO. If the denominated EALO value is zero, then the exemplary bid embodiment system would update 1608 the EALO with the new URL

Continuing with FIG. 19, if the denominated EALO value of the matching EALO is greater than zero, then that means that a currently active bid applies to that EALO. In that case, the exemplary bid embodiment system in function 1607 would update all subsequent-ranked EALOs with URLs from immediately higher-ranked EALOs; and would update user/subscriber information for all down-shifted URLs. This downshifting would have the effect of moving (downshifting in ranking) all subsequent old URLs in all subsequent-ranked EALOs to the next lower-ranked EALOs. The exemplary bid embodiment system would update all of the old URL/subsequent-ranked EALO user/subscribers' information with the new respective rankings. The exemplary bid embodiment system would also update 1608 the matching EALO with the new URL.

It will be understood by someone with ordinary skill in the art that other exemplary bid embodiments of the invention could provide other ranking/bid schemes without departing from the spirit of the invention. For example, in an alternative exemplary bid embodiment, when an advertiser wants to place an advertisement on a particular message board, the advertiser will bid for a particular EALO. If the advertiser's bid for the particular EALO is the highest bid for the highest ranked EALO, then the advertiser will be awarded that EALO, for the duration of a subscription period, unless and until another advertiser places a higher bid for the same EALO or unless and until another advertiser accepts that particular EALO when a higher bid for a higher-ranked EALO is submitted by yet another advertiser.

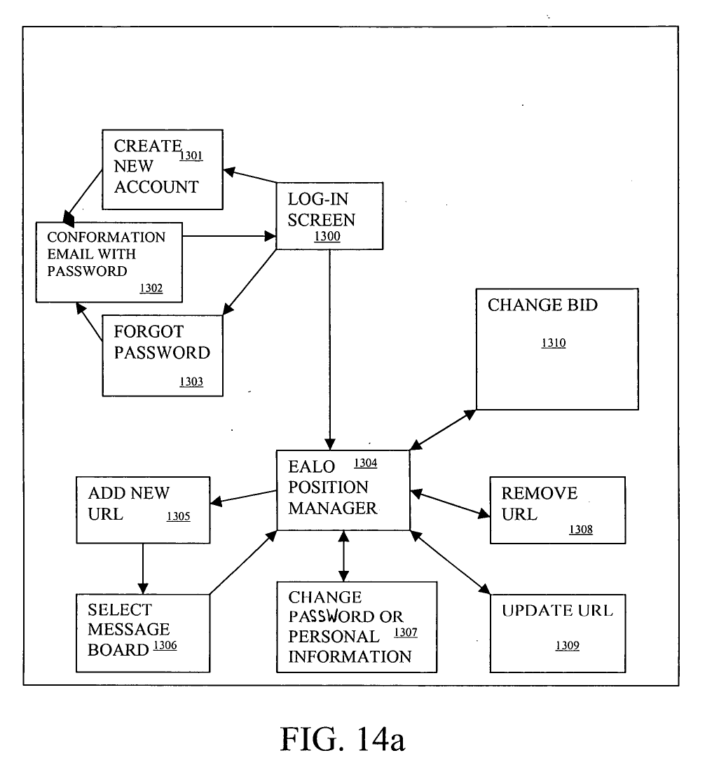

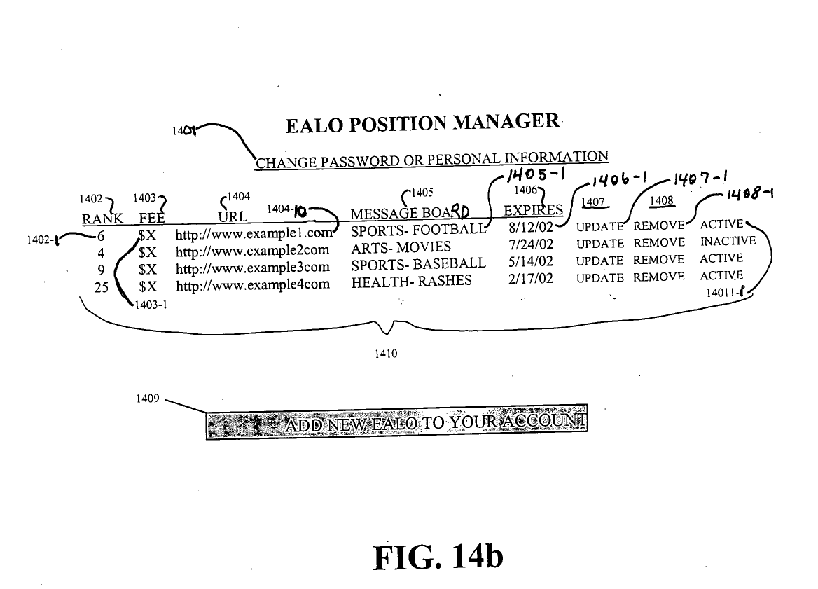

FIG. 14a is a block diagram depicting high level EALO denominated value listing account management functions performed by an exemplary denominated-value listing service of the exemplary bid embodiment of the present invention. As depicted in FIG. 14a, the EALO denominated value listing manager will provide a log-in screen 1300. Log-in screen 1300 will require an input and password to log-in. If the user is new and has not created an account, the Create New Account function 1301 will be performed. After the user enters, and the system receives, appropriate new account information, the subscriber/user will be sent a confirmation email 1302 to access their account. If the subscriber does not remember their password, a Forgot Password routing 1303 will request certain information and will generate an email message 1302 containing the subscriber's password. Once the user has created an account, and once the subscriber has entered a password and properly logged in, the listings management service, sometimes referred to herein as “EALO position manager” 1304 will display various account management options. Exemplary account management options would be, for example, an option to Add a New URL 1305, an option to Select a Message Board 1306 on which to display an advertisement URL, an option to Change Password or Personal Information 1307, an option to Remove a URL 1308, an option to Update an existing URL 1309, and an option to Change Bid 1310. The information displayed in each of these options 1305 through 1310 will be updated automatically through the EALO position manager.

FIG. 14b is a graphic representation depicting an exemplary listing update interface of the exemplary bid embodiment of the present invention. Referring to FIG. 14b, the depicted interface to the EALO position manager displays a link 1401 to change the subscriber's password or personal information. The interface depicted in FIG. 14b further shows an exemplary listing 1410 of all URL links maintained for the particular subscriber's account. As depicted in FIG. 14b, each listed URL, e.g., 1404-10, displays a current ranking 1402-1 within a particular message board 1405-1, the denominated value (fees paid) 1403-1 for the EALO, the URL address 1404-10 for the particular link, the message board location 1405-1, the expiration date 1406-1 for the EALO, a listing removal button 1408-1, an update button 1407-1, and an Add New EALO feature link 1409. The Add New EALO feature link 1409 would provide an interface through which the subscriber would input information to describe a new Embedded Advertising Link on a particular message board.

Continuing with reference to FIG. 14b, using the exemplary EALO position manager user interface, A URL may be added to a particular message board service on the message board database. By logging in with the correct identification, a subscriber may add one or more URLs to the database, update the subscriber's account including any of the listed URL addresses, titles, descriptions, keywords, IDs, and subscription fees. A subscriber can add a new EALO by clicking on the ADD NEW EALO link 1409. The subscriber can use the REMOVE link (e.g., elements 1408/1408-1 in FIG. 14b) to remove a URL, the UPDATE link (e.g., elements 1407/1407-1 in FIG. 14b) to change their URL information, and the CHANGE PASSWORD OR PERSONAL INFORMATION link (e.g., element 1401 in FIG. 14b) to change their password, email address and personal information. A subscriber may also control the URLs active or inactive listing status, e.g., by using the ACTIVE/INACTIVE toggle switch (e.g., element 1411-1 in FIG. 14b)—for example, a user can set a URL to INACTIVE in case the URL is under construction and needs to hide its visibility until completion.

If a new subscriber logs on, the exemplary system would check their status and identify the user as a New Member; the exemplary system would allow the new subscriber to enter their personal information in order to establish a new account. A password would be assigned and would automatically be sent by e-mail to the subscriber's email address. Thus, the New Member can be promptly cleared to commence new listings transactions.

When a subscriber is ready to make payment of the amount or increment to the subscription fee, the system can automatically execute a credit card payment transaction. Once payment is validated, the system will automatically update the database and begin listing the URLs in the appropriate categories and rankings in response to new search queries. Because the positions of the listings are based on objective criteria, i.e., the denominated value paid by the subscriber, the subscriber can pay an increment to improve a listing's position relative to other URLs within the service, and have the new position immediately reflected in the search database. This eliminates the long delays and arbitrary results offered by conventional search services which must evaluate content or classification before adding or updating a listing.

In the exemplary bid embodiment, subscribers would be able to monitor their advertisement's ranking and would be allowed to modify their advertisement's ranking by lowering or raising their subscription fees. Changes to subscription fees, and consequently ranking position, would be handled by the listing server, such as at regular intervals.

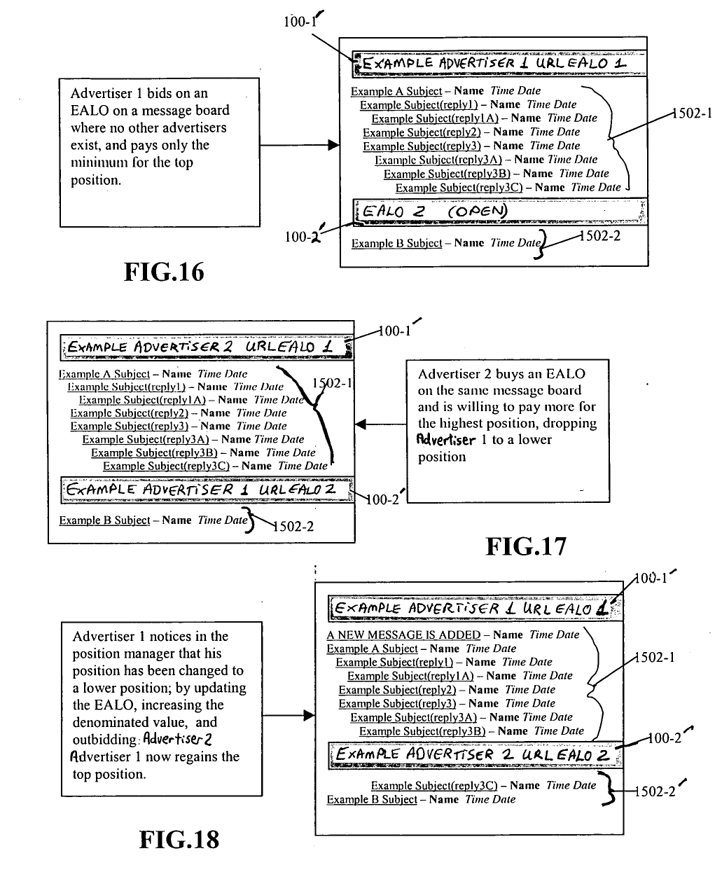

FIG. 16 is a graphic representation depicting an exemplary message board updated with results of a first bid in the exemplary bid embodiment of the present invention. As depicted in FIG. 16, if a first advertiser, e.g., Advertiser 1, bids on an EALO on a particular message board for which no other advertisers have as yet bid for open EALOs, then Advertiser 1 can bid the minimum positive amount for the highest ranked EALO 100-1′; other EALOs on the message board, e.g., 100-2′, will remain open.

FIG. 17 is a graphic representation depicting an exemplary message board updated with results of a second bid in the exemplary bid embodiment of the present invention. As depicted in FIG. 17, if a second advertiser, e.g., Advertiser 2, were to then bid for an EALO on the same message board, if Advertiser 2 is willing to pay more for the highest-ranked EALO, then Advertiser l's URL would be moved to the next highest-ranked EALO, e.g., 100-2′, and Advertiser 2's URL would be updated to the highest ranked EALO 100-1′.

FIG. 18 is a graphic representation depicting an exemplary message board updated with results of a third bid in the exemplary bid embodiment of the present invention. As depicted in FIG. 18, when Advertiser 1 reviews the ranking of Advertiser l's URL in the particular message board's EALOs, Advertiser 1 may decide to increase the bid. If Advertiser I increases the bid, then Advertiser 1's URL will regain the higher-ranked EALO 100-1′, and Advertiser 2's URL will be downshifted to the next highest-ranked EALO 100-2′.

In the exemplary bid embodiment, the denominated value may be based a monetary value or other criteria, depending upon the type of subscriber base being solicited by the listing service. The deriominated value listing server may also be linked to other message board services.

The exemplary bid embodiment of the present invention would allow an individual to create a listings management account through a listing service's monitoring interface. The listing service's monitoring interface is sometimes referred to herein as the EALO position manager.

In the exemplary bid embodiment of the present invention, the listing service's monitoring interface, the EALO position manager, would provide an individual with an interface through which the individual could create a listings management account for one or more Web site submissions. The subscriber would enter detailed information for each Web site submission in each appropriate category. The subscriber would pay for, or renew, their subscription service on a periodic basis. Even so, the listing service's monitoring interface, the EALO position manager, would allow the subscriber to constantly monitor, update, including adding and removing, and/or reposition their listings, depending upon the economic factors that justify the individual's advertisement costs for the Web site.

Exemplary Online Embodiment

In the exemplary embodiment of the present invention, communications between subscribers and users would take place via electronic networks between the central controller 300 and the site listing interface 400, user interface 500, message board interface 600, and administrative interface 1000.

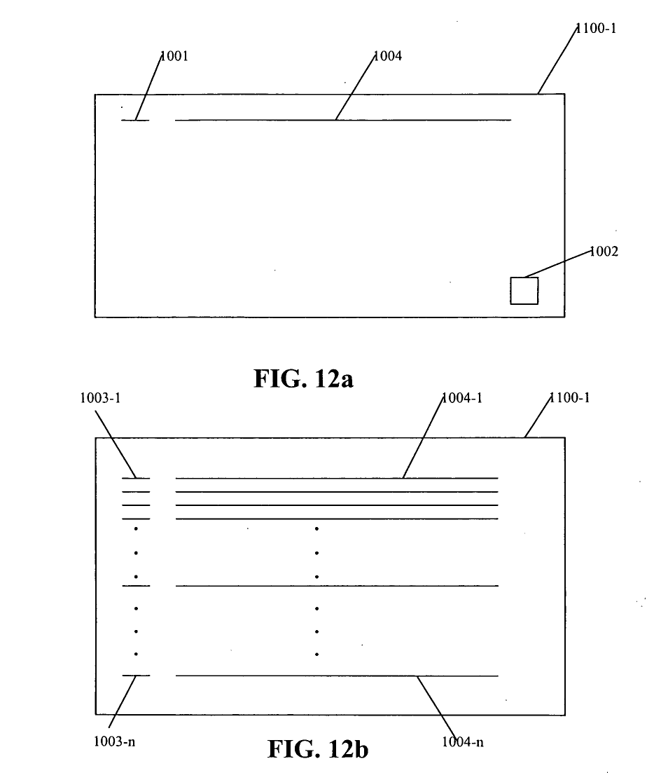

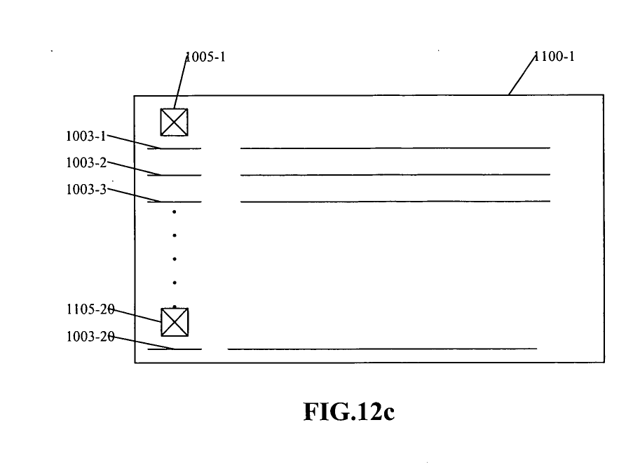

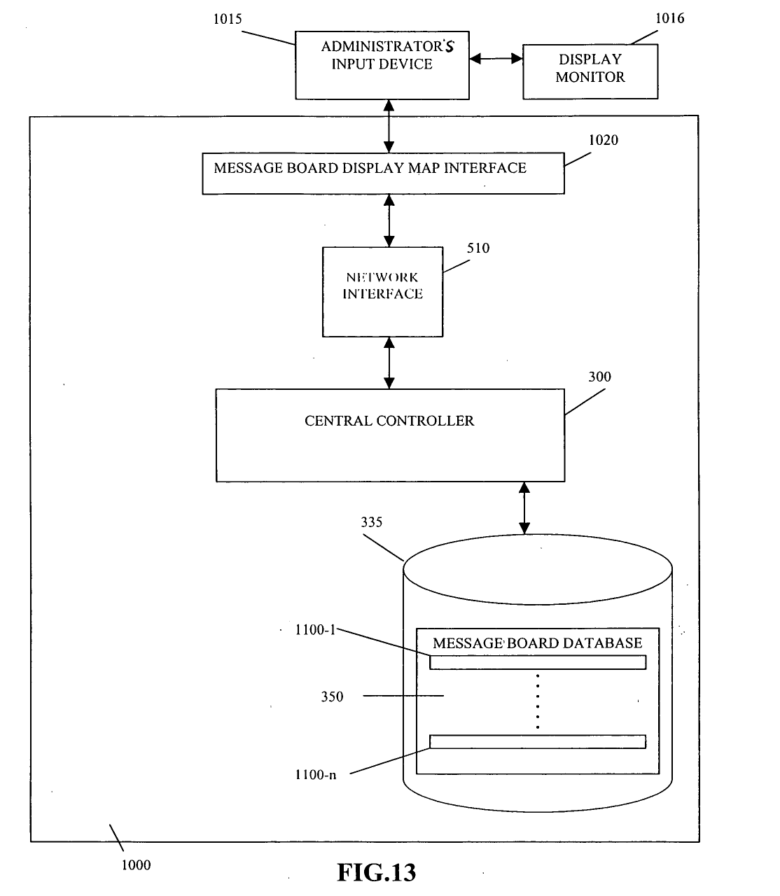

FIGS. 12a through 12c are graphic representations of an exemplary message board administration interface in an exemplary embodiment of the present invention. FIG. 13 is a block diagram depicting high level message board administration interface functional components in an exemplary embodiment of the invention.

In the exemplary embodiment of the invention, as depicted in FIG. 13, an administrator would establish a message board display map for a particular message board by accessing the administrative interface 1000. Using an input device 1015 connected to a display monitor 1016, the administrator would request display of a message board display map 1020. In an embodiment in which the message board site is responsible for controlling more than one message board, the system would prompt the administrator to identify the message board for which the administrator wants to input updates.

In response to the administrator identifying a particular message board, the administrative interface 1000, through the central controller 300, would access the message board database 350 to identify a message board map, e.g., message board map 1100-1, corresponding to the particular message board.

If no message board display map had been previously established for the requested message board, the administrative interface 1000 (FIG. 13) would display a blank message board map 1100-1 such as is depicted in FIG. 12a and would prompt, such as with a blinking cursor, the administrator to input a number. Continuing with FIG. 12a, in such a case, the administrator would input a number into the blank number of lines field 1001 that would represent the total number of lines for the message board. The administrator would then click an enter button 1002.

In response to the administrator entering a number of lines and clicking the enter button 1002, the administrative interface 1000 would generate a display, such as is depicted in FIG. 12b, of a corresponding number of mapping lines 1004-1 through 1004-n for the message board display (where “n” would correspond to the number of lines input by the administrator. Continuing with FIG. 12b, each mapping line 1004-1 through 1004-n would display a companion indicator field 1003-1 through 1003-n respectively.

It should be noted that the use of suffixes such as “a” through “n” in connection with numbered elements of the FIGURES herein are exemplary and are not a limitation of the invention. Rather, the suffixes “a” through “n” are used to represent a plurality, but unknown number, of similar elements.

The administrator would then be prompted to indicate which of the lines should be reserved for an EALO. To do this, the administrator would, for example, click the indicator field, for example 1003-1 and 1003-20 as depicted in FIG. 12c. When the indicator fields, for example 1003-1 and 1003-20 as depicted in FIG. 12c have been clicked, the administrative interface would designate, for example with an icon 1005-1 and 1005-20 as depicted in FIG. 12c, that the line is reserved for an EALO. In one embodiment, the line number of the mapping line is also displayed for reference.

Referring now to FIG. 5, in the exemplary embodiment, a subscriber would log into the site listing interface 400 through the message board interface 600 and central controller 300 by clicking on an available EALO (e.g., 100-1, FIG. 4a) displayed on the message board. As described further below, as an alternative, the subscriber could subscribe to an EALO by non-electronic communications through other means. In response to the subscriber selecting an available EALO (e.g., 100-1, FIG. 4a) within the message board display, the site listing interface 400 would invoke, via a Network interface 410, the embedded advertising link offer interface 700.

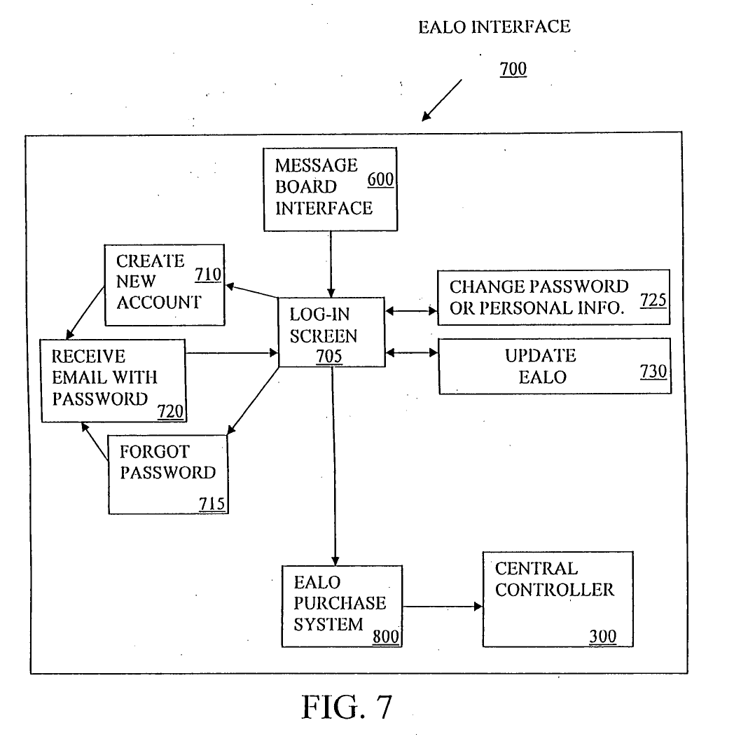

Turning now to FIG. 7, after the embedded advertising link offer (EALO) interface 700 has been invoked, the embedded advertising link offer (EALO) interface 700 would prompt the subscriber to log in through a log-in screen 705. If the subscriber does not have an account, the subscriber can create a new account 710 and then receive an email containing a password 720 to access the system. If the subscriber has an existing account and has forgotten the password, the subscriber has the option of having the password sent to the subscribers email address 715 via email communications. If the subscriber successfully logs on and already has an account, the subscriber will have the option of changing their password or personal information 725, and the option of updating an existing EALO 730. Once the subscriber has successfully logged in to the embedded advertising link offer interface 700, control is transferred to the EALO purchase system 800 to complete the purchase of an EALO.

Referring now to FIG. 8, after the subscriber has logged-in, control is passed to the EALO purchase system 800. The system confirms that the subscriber has logged on the EALO system 805. The system then prompts, and receives and validates input of, 810 the subscriber's input of information 815 in order to complete the purchase of an available EALO. The requested information 815 may include username, password, company name, and contact information, designated to display the EALO.

Continuing with FIG. 8, the system prompts, and receives and validates input 820 of, the subscriber's input of Internet site listing information 825 that will be used to generate a display at the purchased EALO. The subscriber Internet site listing information may include the subscriber link title, a brief description, and the Web site address.

Once the system has collected the requested information, the system generates, and provides the subscriber with, a conditional preview display 830 of the proposed EALO on the message board. The system will then prompt the subscriber to indicate, and will receive as input, an expiration date 835. In the exemplary embodiment, the subscriber is provided with a selection of expiration time periods of one month, three months, six months, or a year.

The system will prompt, and receive and validate input of, the subscriber's input of an indication of acceptance of the conditional preview display of the proposed EALO on the message board through input of payment information 840. In the exemplary embodiment, the system will process, and accept when appropriate, credit and debit card payments. The system will present the subscriber with a legal disclaimer 850. If the user accepts the legal disclaimer, the system will pass subscriber information and successful payment information through the site listing interface 400 (not shown) to the central controller 300. The central controller 300 will generate an actual message board display and will then post the display through the message board interface 600 to the message board display. At the same time, the central controller 300 will store the payment information in a payment database 360; the central controller 300 will store subscriber information in the subscriber database 345 and will store the internet site listing information in the EALO database 380.

Once the system has established an account for a subscriber, the system will monitor activity in the system for that account, including subscriber activity and performance for the subscriber's EALO(s).

As depicted in FIG. 10, the message board interface 600 is a primary gateway through which users interact with the central controller 300. The message board interface 600 determines the number of lies that will appear per page of display on a message board. The message board interface 600 determines which lines of the message board display will be reserved for user messages and which lines of the message board display will be reserved for subscriber EALOs.

FIG. 6 is a block diagram depicting high-level functions of an exemplary user interface in an exemplary embodiment of the present invention. As depicted in FIG. 6, a user, using a user input device 515, would log into the user interface 500 of the system and would enter a message to be posted to the message board through the message board interface 900. The user message is passed to the central controller 300 through a network interface 510.

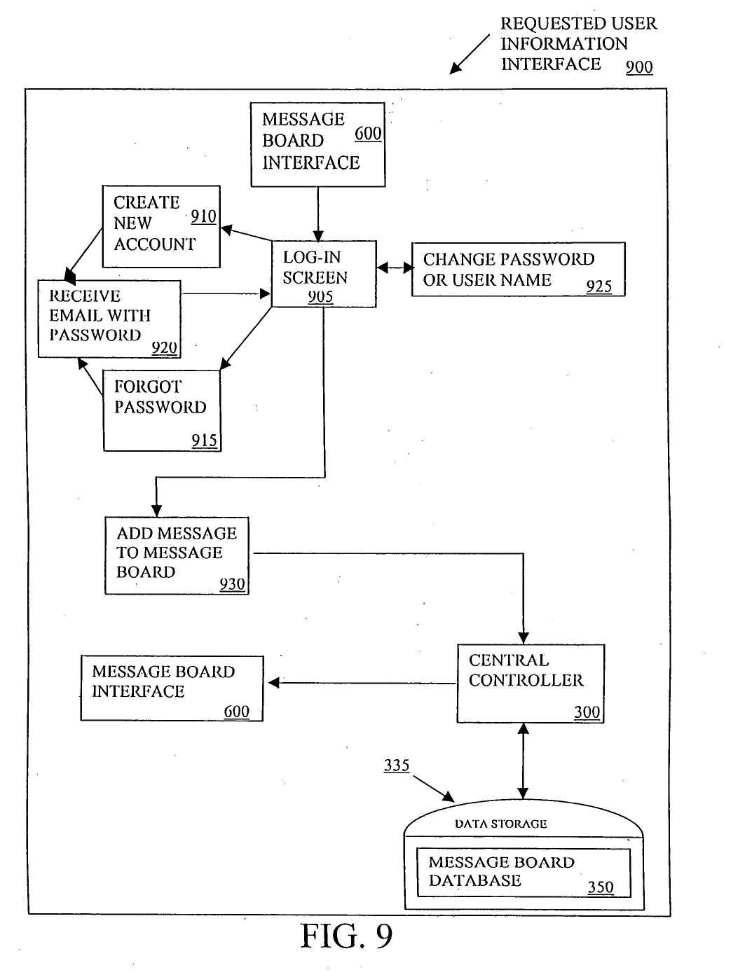

FIG. 9 is a block diagram depicting high-level functions of an exemplary message board interface for posting user messages to an exemplary message board system in an exemplary embodiment of the present invention. As depicted in FIG. 9, the system presents the user first with a log-in screen 905. If the user does not have an account, the system would prompt the user to create an account 910; the system would send the user a password via email 920. If the user has forgotten the password, the system would prompt the user to request that their password be sent via email 915 and would send the user their password 920. Once the user has logged-in successfully, the user can change password or user name information 925. After logging into the system, the user will be allowed to add a message 930 to the message board, inputting information into such fields as title, message, and optional email. The system would then pass the message data to the central controller 300, where it would be stored in the message board database 350 in the data storage device 335 and would be posted to the message board through the message board interface 600.

FIG. 11 is graphic illustration depicting illustrative user and subscriber interactions with an exemplary embodiment of the invention. As depicted in FIG. 11, a user message 102 is displayed through the message board interface 600 and outputted to specific lines on the message board 1200 (the message board interface 600 will determine the manner (date, subject or thread order) in which the messages will be displayed. The message board interface 600 is composed of applications that enable the display of user messages to be shifted down the message board page 1200 as new message, e.g., 102, are added; at the same time, the message board interface 600 will display EALOs (embedded adverting links) in positions within the message board page 1200 that are permanent and do not shift up or down on the message board page 1200.

The culmination of both the user inputted data and the subscriber submitted EALOs, is that the message board interface 600 is able to take the separate data pertaining to both users and subscribers and through various applications display the information on the specified line numbers creating the embedded style of site listings within the message board system.

FIG. 10 is a block diagram depicting high-level functions of an exemplary message board interface for posting both user messages and subscriber advertisements to an exemplary message board system in an exemplary embodiment of the present invention. As shown in FIG. 10, in the exemplary embodiment of the present invention, the process by which a subscriber or user accesses the central controller 300 would be through the message board interface 600. The message board interface 600 would provide programs to specifically configure the message board to display a predetermined number of lines in which data may be outputted. Each output line of the message board display 615 will be either designated for user messages or will be reserved for subscriber EALOs. The lines within the message board display 615 that are reserved for EALOs, can be according to any configuration within the message board display, including, embedded among the user messages; the configuration of the message board display can be established through the message board administrative interface as previously discussed.

The message board interface 600 obtains, through the central controller 300, the messages and EALOs to be displayed in the particular message board. In the exemplary embodiment of the present invention, there would be a message board display map (as disclosed above in connection with the description of FIGS. 12a through 12c) that would be established through the message board administrative interface. In the message board display map, each line of the message board display would be numbered and would contain an indicator as to whether the line was designated for user messages, or whether the line is available for an EALO. In the exemplary embodiment, the EALO database 380 (depicted, e.g., in FIG. 8) would contain only those EALOs for which a subscriber had purchased an available EALO and input the information required for display. Each EALO record on the EALO database 380 (depicted, e.g., in FIG. 8) would contain the message board ID number of the message board for which the EALO is designated; each EALO record would also contain a line number within the corresponding message board display map that corresponds to the line numbered EALO that was selected and purchased by the purchasing subscriber.

To generate the message board display 615, as depicted in FIG. 10, the message board interface 600 would access user databases 605, including the message board database 350 (FIGS. 6 and 9), and would access subscriber databases, including the EALO database 380 (FIG. 8), to obtain the messages and purchased EALOs to be displayed in the message board display 615. The message board interface 600 sorts the messages to be displayed according to the particular type of user format request (date-ordered, subject ordered, or theme-ordered). The message board interface 600 then generates the message board display 615 by inserting, according to the order of the requested display, each subsequent message, according to the message board display map, into the next available message board display line; the message board interface inserts each purchased EALO into a line of the message board display 615 according to the purchased EALO line number. In this way, the message board interface 600 inserts each purchased EALO for the particular message board in a line within the message board display 615, such that the line corresponds to a line selected by the particular subscriber the purchased the particular EALO.

Exemplary Online Bid Embodiment

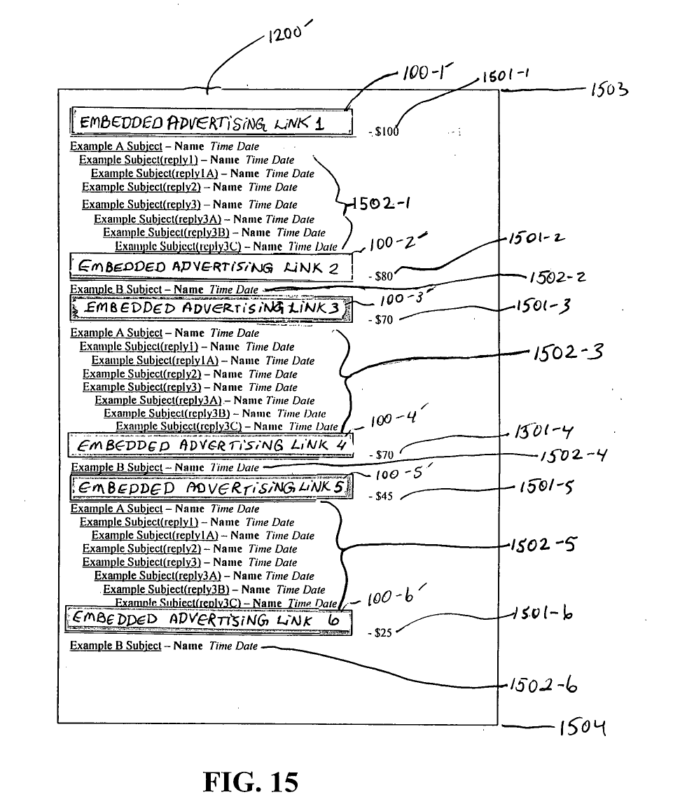

FIG. 15 is a graphic representation depicting an exemplary message board 1200′ updated with results of the denominated-value EALO service in an exemplary bid embodiment of the present invention. As depicted in FIG. 15, each embedded advertising link offer (EALO), e.g., 100-1′ through 100-6′, is displayed on the message board page 1200′ with an associated denominated value, e.g., 1501-1 through 1501-6 respectively. Further, as depicted in FIG. 15, the display of EALOs, e.g., 100-1′ through 100-6′, is ordered according to a denominated-value ranking—that is, in the example depicted in FIG. 15, the EALO 100-1′ depicted toward the top 1503 of the message board page 1200′ has the highest denominated ranking (not shown), e.g., 6 on a scale of 1 to 6, where 6 is the highest ranking. The lowest ranked EALO 100-6′ is displayed toward the bottom 1504 of the message board page 1200′. The lowest ranked EALO 100-6′ has the lowest denominated ranking for the exemplary message board, e.g., 1 on a scale of 1 to 6 where 6 is the highest ranking. The example depicted in FIG. 15 also displays the highest denominated value 1501-1 of $100 for the highest ranked EALO 100-1′ as compared to the lowest denominated value 1501-6 of $25 for the lowest ranked EALO 100-6′, which is displayed toward the bottom 1504 of the message board page 1200′.

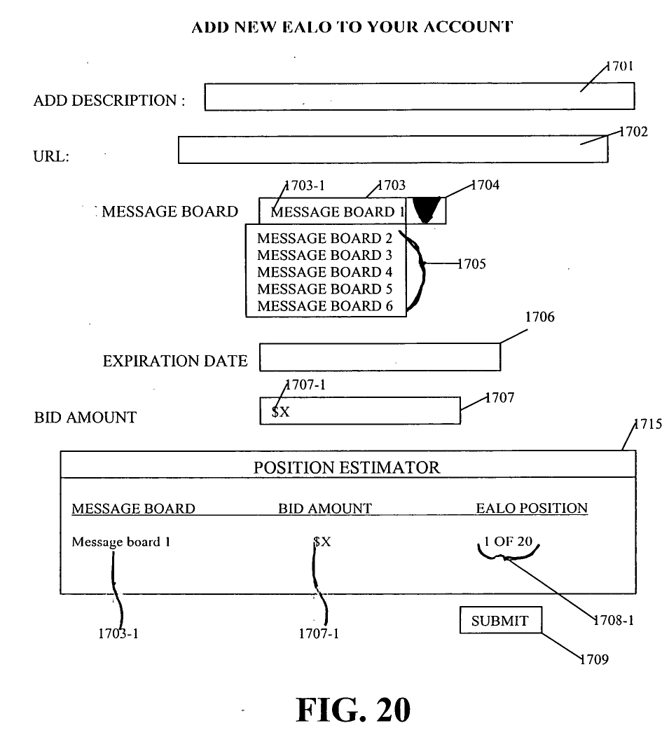

FIG. 20 is a graphic representation of an exemplary Add New EALO interactive user interface screen in the exemplary bid embodiment of the present invention. As depicted in FIG. 20, after a user/subscriber has clicked on the ADD NEW EALO link (see element 1409, FIG. 14b), the exemplary bid embodiment system would present an Add New EALO interactive user interface screen comprising a Description input field 1701, a URL input field 1702, a message board identification input field 1703 (with an accompanying pull-down menu button 1704), an expiration date input field 1706, and a bid amount input field 1707. The exemplary bid embodiment system would also present a POSITION ESTIMATOR window 1715 that would list the message board 1703-1, the bid amount 1707-1 and the estimated EALO position 1708-1 that would be provided as a result of a particular bid amount 1707-1. In the exemplary interface depicted in FIG. 20, no previous bidders have been awarded any EALOs on the particular message board 1703-1; any positive bid would obtain the highest ranked position (1 out of 20) of the 20 available EALOs on the relevant message board (MESSAGE BOARD 1 1703-1). If the user is satisfied with the estimated position 1708-1, the user would submit the bid by clicking the SUBMIT link 1709.

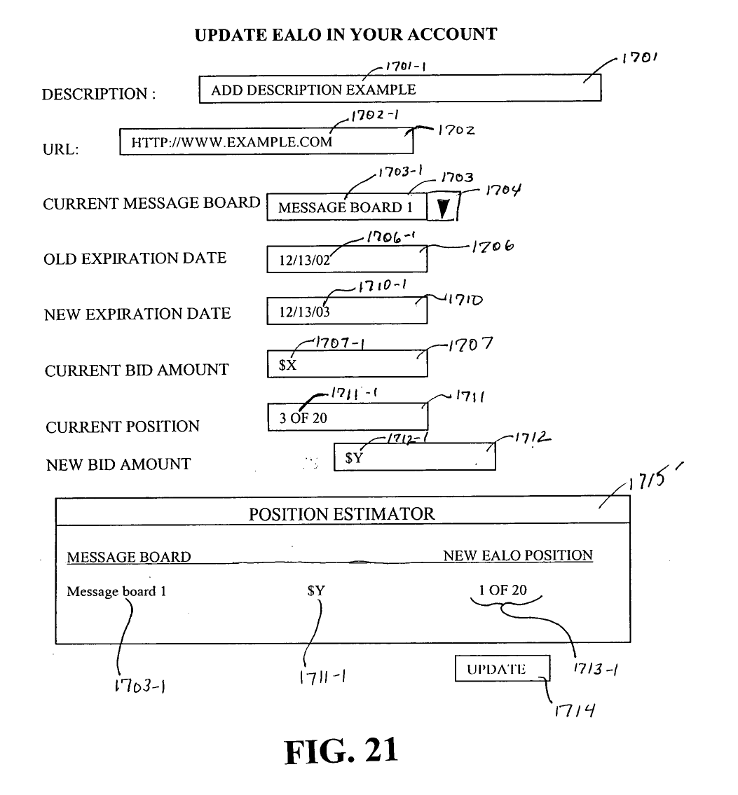

FIG. 21 is a graphic representation of an exemplary Update EALO interactive user interface screen in the exemplary bid embodiment of the present invention. If a user clicks the UPDATE link (e.g., 1407-1, FIG. 14b) for an existing EALO-listed URL, the exemplary bid embodiment system would present the exemplary Update EALO interactive user interface screen depicted in FIG. 21, pre-populated with the user's previous input Description 1701-1, URL 1702-1, message board identifier 1703-1, old expiration date 1706-1, current bid amount 1707-1, and current position 1711-1. The exemplary Update EALO interactive user interface screen depicted in FIG. 21 would provide a new bid amount input field 1712 for input of a new bid amount 1712-1. The exemplary Update EALO interactive user interface screen depicted in FIG. 21 would also provide a new expiration date input field 1710 for input of a new expiration date 1710-1. If the user inputs a new bid amount 1712-1, the exemplary bid embodiment system would calculate and display a Position Estimator window 1715′ that would report, for the particular message board 1703-1, for the new bid amount 1711-1, the new EALO position 1713-1. If the user is satisfied with the new estimated position 1713-1, then the user would submit the new bid by clicking on the “UPDATE” link 1714.

Off-Line Embodiment

In one alternative embodiment of the present invention, subscribers communicate in an off-line manner with the central controller 300. Instead of sending electronic mail or using web-based servers to communicate with the central controller 300, subscribers use a telephone, fax machine, postal service, or other off-line communication tools.

In such an off-line alternative embodiment, a subscriber may use a telephone, for example, to select and purchase a particular EALO. Using a telephone, the subscriber dials and is connected with an EALO agent. The subscriber identifies a particular EALO, and provides such information to the EALO agent as subscriber name, subscriber company name, contact information, EALO content title, brief description, web site address, and payment information. The agent also provides the subscriber with a subscriber ID, password and username. The agent then enters this data into the system so that the system, via the central controller 300, adds the information to the relevant databases and displays the advertisement at the predetermined position in the appropriate message board display in a manner as described in the on-line embodiment.

Subscribers may also communicate with an agent at central controller 300 through faxes or postal mail. The agent receives the message and proceeds to digitize it and form an EALO 100 as described above.

### ONLINE EXAMPLE I

Referring to FIG. 11, in this example, a potential subscriber visits a message board and sees that there is an available EALO 100-1 a located on the ninth line out of a total number of lines displayed on a particular page 1200 of the message board. Continuing with reference to FIG. 11, the potential subscriber would click 701 on the available EALO 100-1 a and would be taken to the site listing interface 400. The subscriber would then log on to the EALO interface 700 and enters a username and password. The subscriber would then be taken to the EALO purchase system 800 (see FIG. 8) where specific information must be inputted to complete the transaction. Once all information has been collected and payment preference has been has been chosen, the subscriber would conclude the process by agreeing to the legal disclaimer 850 (see FIG. 8) and would officially be given the confirmed username and password which will allow the subscriber to log on to the system at a later date and change the information or extend the period for which the EALO 100-1 b will be displayed on the message board. The central controller 300 would post the new EALO 100-1b to the message board 1200 through the message board interface 600. Once the EALO 100-1b has expired for this particular subscriber, a notice will be sent out, and the EALO 100-1a on that line number will once again become available for others subscribers to pick and submit there own EALO to be displayed.

Continuing with FIG. 11, a user may submit messages 901 by logging onto the user interface 500; the user would be connected to the add message to message board interface 900 (see FIG. 6), where after successful completion, the message will be added to the message board page 1200. As shown in FIG. 11, the message board interface's 600 applications will distinguish between EALOs, e.g., 100-1b, and user messages, and will be able to place the new message 102 on the message board page 1200 and will reorganize the remainder of the message board lines on that page 1200 so that the position of the purchased EALO 100-1b is not disturbed. As depicted in FIG. 11, prior to the new user message 102 being added to the message board 1200, the available EALO 100-1a and the purchased EALO 100-1b, both occupy the ninth line of the message board page 1200. When the new user message 102 is added as the first line of the message board page 1200, the remainder of the message lines on that page 101-1 through 101-9 are scrolled downward without disturbing the ninth-line position of the purchased EALO 100-1b—that is, after adding the new user message 102, the line 101-7 user message follows, instead of precedes, the EALO 100-1b.

### ONLINE EXAMPLE II

In this example, each new web site being added to the system is entered with required information such as email address, password, personal and web site data. The subscriber will enter their email address and a password to control access to the EALO position manager database. The subscriber selects the appropriate message board for each web site they wish to add. They can enter as many web sites as they choose. The service reserves the option to verify that the message board preference indicated matches the general content of the site. The subscriber can select any subscription fee they choose, which is good for a one year subscription period. At prescribed adjustment periods, such as weekly, the subscriber may log on to the listings management program, and adjust the subscription fee upward if maintenance of a desired position against competitors or a higher position is desired. The original expiration date of one year remains regardless of any change to subscription fees. At the end of the original expiration date, the user has the option of renewing the subscription at the current fee or any other fee desired. All subscription fees are paid in advance and no refunds are given.

The web site listings in index or message board category are displayed in fee order from highest to lowest. Listings at the same fee level are displayed on a first come, first served basis. Fee-based submissions will be added to the database immediately and reviewed at a later date. This will allow the subscriber to obtain an immediate Web site placement. If the indicated message board is incorrect, the listing will be moved to a more appropriate message board or removed from the database.

In effect, this exemplary type of service allows a subscriber to choose the rank of their listing by selecting an appropriate initial fee followed by any necessary adjustments to maintain or increase its ranking. The transaction can be completed in a few minutes on-line with a credit card payment or other credit given, thus avoiding high transaction costs and delays for content review. Following the close of the time for adjustment, the rankings are locked in for the duration of the adjustment period, but may thereafter be further adjusted.

Trademarks

The names of actual companies and products mentioned herein may be the trademarks of their respective owners.

Facsimile Reproduction of Copyright Material

A portion of the disclosure of this patent document contains material which is subject to copyright protection by the copyright owner, Robert Wycoff, his successors and assigns (the “copyright owner”). The copyright owner has no objection to the facsimile reproduction by anyone of the patent document or the patent disclosure, as it appears in the Patent and Trademark Office patent file or records, but otherwise reserves all copyright rights whatsoever.

Illustrative Embodiments

Although this invention has been described in certain specific embodiments, many additional modifications and variations would be apparent to those skilled in the art. It is, therefore, to be understood that this invention may be practiced otherwise than as specifically described. Thus, the embodiments of the invention described herein should be considered in all respects as illustrative and not restrictive, the scope of the invention to be determined by the appended claims and their equivalents rather than the foregoing description.

1. A network-based message board system, said system compromising:
a listing server connected to a network accessible by a plurality of users;
a message board site listings database accessible by the listing server, said site listings database comprising a plurality of site listings, wherein each site listing comprises an embedded advertising link offer identifier, and a Web site address; and
an embedded advertising link offer database accessible by the listing server, said embedded advertising link offer database comprising a plurality of embedded advertising link offers, wherein each embedded advertising link offer comprises an embedded advertising link offer identifier, a corresponding message board identifier, and an identifier of a particular display position within a fixed number of displayable positions on a message board that corresponds to said message board identifier.

2. The system of claim 1, said system further comprising:
a message board display program means, said message board display program means comprising executable program instructions for displaying a plurality of messages corresponding to a particular message board; and
said message board display program means further comprising executable program instructions for displaying each site listing of a plurality of site listings corresponding to the particular message board wherein each site listing is displayed on the particular display position corresponding to the particular embedded advertising link offer corresponding to the particular site listing.

3. The system of claim 1, said system further comprising:
an account interface to the network wherein said account interface is accessible by a plurality of subscribers, and wherein said account interface comprising a set of program instructions for receiving information input by respective subscribers corresponding to a particular site listing.

4. The system of claim 1, wherein each embedded advertising link offer in the embedded advertising link offer database further comprises a fixed denominated value.

5. The system of claim 1, wherein each site listing in the message board site listings database further comprises a denominated value.

6. The system of claim 5, wherein the denominated value comprises a subscriber-determined bid amount input by a particular subscriber.

7. The system of claim 6, wherein said bid amount may be adjusted by the particular subscriber during a defined adjustment period.

8. The system of claim 3, wherein said account interface further comprises means for allowing a subscriber to enter a particular bid amount for a particular site listing.

9. The system of claim 8, wherein said account interface provides means for each subscriber to search and view site listings previously entered by the particular subscribe, wherein said account interface provides means for displaying said site listings for the particular subscriber ranked in comparison to denominated values of other site listings entered by other subscribers.

10. The system of claim 9, wherein said account interface further provides means for each subscriber to enter a new bid amount in order to change the ranking of said subscriber's site listing relative to those of the other subscribers.

11. The system of claim 3, wherein said account interface further comprising:
a set of program instructions for maintaining for each particular subscriber a set of information for a plurality of embedded advertising link offers.

12. A network-based message board system, said network-based message board system comprising a set of computer instructions for:
displaying a hypertext link on a predetermined line number within a fixed number of lines of a message board display.

13. The network-based message board system of claim 12, said network-based message board system further comprising a set of computer instructions for:
updating the message board display with a new message; and
preserving the hypertext link position at the predetermined line number of the message board display.

14. A network-based message board system, said network-based message board system comprising a set of computer instructions for:
preserving a position of an advertising link at a fixed display position within a message board display.

15 A method for embedding a hypertext link in an Internet message board display, said method compromising:
displaying on a predetermined set of particular display line positions within a fixed number of display line positions on a particular Internet message board a plurality of offer displays.

16. The method of claim 15 wherein each particular display line position in the predetermined set of particular display line positions comprises a single offer display.

17. The method of claim 15 wherein each particular display line position of the predetermined set of particular display line positions is dedicated to displaying either a single offer display to sell the displayable space on the respective particular display line position or a single display by a subscriber.

18. The method of claim 17 wherein each subscriber display comprises a hypertext link.

19. The method of claim 17 wherein the subscriber has paid a predetermined fee for a predetermined period of time for displaying the subscriber display.

20. The method of claim 17 wherein the subscriber has paid a bid for a particular period of time for displaying the subscriber display;

21. The method of claim 20 wherein the particular subscriber display may be repositioned among the predetermined set of particular display line positions within the fixed number of display line positions
